(19) United States
(12) Patent Application Publication
(10) Pub. No.: US 2017/0176904 A1
(43) Pub. Date: Jun. 22, 2017

(54) IMAGE FORMING APPARATUS WITH FIXING UNIT INCLUDING ELECTRIC HEATING WIRE HEATER

(71) Applicant: Konica Minolta, Inc., Tokyo (JP)

(72) Inventors: Taku Kimura, Aichi-Ken (JP); Mikiyuki Aoki, Aichi-Ken (JP); Seiichi Kirikubo, Aichi-Ken (JP); Takeshi Tamada, Aichi-Ken (JP); Akinori Kimata, Aichi-Ken (JP)

(73) Assignee: Konica Minolta, Inc., Tokyo (JP)

(21) Appl. No.: 15/382,271

(22) Filed: Dec. 16, 2016

(30) Foreign Application Priority Data
Dec. 16, 2015 (JP) 2015-245063

(51) Int. Cl. G03G 15/20; H02M 1/00; H02M 7/46

(52) U.S. Cl. CPC G03G 15/2039; H02M 7/46; H02M 1/00; G03G 15/80; H02M 2001/0009

(57) ABSTRACT

An image forming apparatus includes a fixing unit that includes a roller and an electric heating wire heater, a current applying circuit that applies electrical current to the electric heater wire heater, a measuring unit electrically connected to the current applying circuit and that measures a value of electrical current that flows through the electric heating wire heater, and a controller that controls the electrical current that flows through the electric heating wire heater by controlling the current applying circuit based on the electrical current value measured by the measuring unit. The controller controls the electrical current to be less than or equal to an electrical current limit value. A magnitude of the electrical current limit value is linked to a magnitude of stable state electrical current.

This application is based on Japanese Patent Application No. 2015-245063 filed with the Japan Patent Office on Dec. 16, 2015, the entire content of which is hereby incorporated by reference.

### BACKGROUND OF THE INVENTION

Field of the Invention

The invention relates generally to an image forming apparatus and a control method for an image forming apparatus. More specifically, one or more embodiments relate to an image forming apparatus and a control method for an image forming apparatus equipped with a fixing unit which includes an electric heating wire heater and a current applying circuit for applying electrical current to the electric heating wire heater,

Description of the Related Art

As an electrophotographic image forming apparatus, there are an MFP (Multi Function Peripheral) with a scanner function, a facsimile function, a copying function, a function of a printer, a data transmitting function and a server function, a facsimile device, a copying machine, a printer, and so on.

An image forming method according to a generic image forming apparatus is as follow. An image forming apparatus electrostatically charges a photo conductor (an image supporting body) by using an electrostatic charging device. An electrostatic latent image is formed on the photo conductor by laser beams emitted from an expose device. The image forming apparatus develops the electrostatic latent image by using a developing device to form a toner image, and transfers the toner image onto a sheet by using a transfer roller. The image forming apparatus fixes the toner image onto the sheet by a fixing device to form an image on the sheet.

Recently, according to the ErP protocol, the Blaue Enger, the International Energy Star Program or the like, environment standards for image forming apparatuses are stringently regulated. From the point of view of consumption energy reduce, the necessity of quick warm-up for an image forming apparatus (shortening time for warm-up) is increasing. To tackle the quick warm-up for an image forming apparatus, the heat capacity of a fixing roller in a fixing device is being lowered.

When the heat capacity of the fixing roller is low, the fixing roller can be heated in a short time. However, since such the fixing roller cannot store enough thermal energy, the frequency of turning on/off of the heater (a halogen heater or the like) for heating the fixing roller is increased. It becomes easier to cause a flicker. A flicker is a phenomenon to cause flickering on lighting equipment or the like connected to the same electric power supply, by fluctuation of electrical voltage of the electric power supply. The fluctuation is caused by large load fluctuation of equipment connected to the electric power supply.

Conventional techniques for reducing the flicker are disclosed in documents 1 and 2 below, for example. Document 1 discloses an electrical voltage fluctuation reduction circuit comprising a rectification unit for rectifying commercial electric power supply, a switching unit for providing electrical current by switching the rectification output from the rectification unit at a frequency which is higher than the frequency of the commercial electric power supply, an electrical current detecting unit for detecting electrical current supplied from the switching unit, and a controller for controlling on/off of the switching unit based on the detection result of the electrical current detecting unit and an electrical current limit value by the rectification output.

Document 2 below discloses a control device for a fixing heater. For controlling a phase of a halogen heater, when the fixing temperature is high, changes of the phase angle for soft starting are made smaller to shorten the time.

### Documents

[Document 1] Japan Patent Publication No. (HEI) 11-202680

[Document 2] Japan Patent Publication No. (HEI) 11-249485

An image forming apparatus has a plurality of behavior modes, such as a warm-up mode, a printing mode, a standby mode, and so on. Average quantity of electrical current which flows through the heater largely differs among behavior modes.

To shorten warm-up time of an image forming apparatus, electrical current large if at all possible is supplied to the heater of the fixing device when the warm-up. Therefore, in case that a constant electrical current limit value is configured for the electrical current which flows through the heater as described in Document 1, the electrical current limit value should be set to a large value being consistent with electrical current which flows when the warm-up.

At a stable state during standby, electrical current which flows through the heater in the fixing device is a tiny amount. On the other hand, when the heater is turned on during the standby, large electrical current (inrush electrical current) temporarily flows through the heater. In consequence, even though the electrical current which flows through the heater is below the electrical current limit value, the difference from electrical current at the stable state of standby is big. Hence, there is a risk that the flicker worsens.

### SUMMARY OF THE INVENTION

One or more embodiments provide an image forming apparatus and a control method for an image forming apparatus which improves a flicker.

An image forming apparatus according to one or more embodiments of the present invention comprises a fixing unit which includes an electric heating wire heater, a current applying circuit to apply electrical current to the electric heating wire heater, a measuring unit to measure an electrical current value which flows through the electric heating wire heater, and a controller to control electrical current which flows through the electric heating wire heater, by controlling the current applying circuit, based on the electrical current value measured by the measuring unit, wherein the controller controls the electrical current which flows through the electric heating wire heater, so that the electrical current which flows through the electric heating wire heater is less than or equal to an electrical current limit value configured, wherein magnitude of the electrical current limit value is configured to be linked to magnitude of stable state electrical current which is electrical current value when the electrical current which flows through the electric heating wire heater is stable.

According to one or more embodiments of the image forming apparatus, the electric heating wire heater is a halogen heater, and the current applying circuit includes a rectification circuit to rectify input alternating electrical current, and a step down chopper circuit which consists of a switching element, a back-flow element and a reactor, to switch electrical current rectified by the rectification circuit, by the switching element on and off, and apply the electrical current to the electric heating wire heater, wherein the controller controls the switching element by using pulse width modulation, and magnitude of the stable state electrical current is linked to magnitude of the duty of the pulse width modulation which controls the switching element.

According to one or more embodiments of the image forming apparatus, the controller includes a PWM controller to configure the duty, and an electrical current limit controller to control electrical current which flows through the electric heating wire heater by controlling the switching element based on the electrical current value measured by the measuring unit and the duty configured by the PWM controller.

According to one or more embodiments of the image forming apparatus, the controller further includes a first memory to beforehand store correspondence relationship between the duty and the electrical current limit value, and the electrical current limit controller controls electrical current which flows through the electric heating wire heater, so that the electrical current is less than or equal to an electrical current limit value which was configured, based on the duty configured by the PWM controller and the correspondence relationship stored in the first memory.

According to one or more embodiments of the image forming apparatus, the controller further includes a calculator to calculate the electrical current limit value by using the electrical current value measured by the measuring unit, the electrical current limit controller controls electrical current which flows through the electric heating wire heater, so that the electrical current is less than or equal to the electrical current limit value which was configured based on the correspondence relationship stored in the first memory, when the electrical current which flows through the electric heating wire heater is unstable, and the electrical current limit controller controls electrical current which flows through the electric heating wire heater, so that the electrical current is less than or equal to the electrical current limit value which was calculated by the calculator, when the electrical current which flows through the electric heating wire heater is stable.

According to one or more embodiments of the image forming apparatus, the controller includes a calculator to calculate new electrical current limit value by using the electrical current value measured by the measuring unit, after the electrical current which flows through the electric heating wire heater becomes stable, and an update unit to update the electrical current limit value stored in the first memory to the new electrical current limit value calculated by the calculator.

According to one or more embodiments of the image forming apparatus, the controller further includes a second memory to beforehand store correspondence relationship between behavior modes of the image forming apparatus and electrical current limit values, the behavior modes include warm-up, print and stand-by, and the electrical current limit value in the correspondence relationship stored in the second memory decreases in the order of the electrical current limit value of the warm-up, the electrical current limit value of the print, and the electrical current limit value of the stand-by, and the electrical current limit controller controls electrical current which flows through the electric heating wire heater, so that the electrical current is less than or equal to the electrical current limit value which was configured based on an actual behavior mode of the image forming apparatus and the correspondence relationship stored in the second memory.

According to one or more embodiments of the image forming apparatus, the controller further includes a temperature configuration reception unit to receive a temperature configuration of the fixing unit, and a third memory to beforehand store correspondence relationship between temperature of the fixing unit and the electrical current limit value, and the electrical current limit controller controls electrical current which flows through the electric heating wire heater, so that the electrical current is less than or equal to the electrical current limit value which was configured based on the temperature configuration received by the temperature configuration reception unit and the correspondence relationship stored in the third memory.

According to one or more embodiments of the image forming apparatus, the electrical current limit controller controls electrical current which flows through the electric heating wire heater, so that the electrical current is less than or equal to an upper limit of an allowable range of electrical current which can flow through the switching element.

One or more embodiments of the image forming apparatus further comprise an electrical voltage measuring unit to measure the electrical voltage of the input alternating electrical current, and a correction unit to correct the electrical current limit value so that the electrical current limit value decreases, when the electrical voltage measured by the electrical voltage measuring unit is higher than a predetermined electrical voltage value, and correct the electrical current limit value so that the electrical current limit value increases, when the electrical voltage measured by the electrical voltage measuring unit is lower than a predetermined electrical voltage value, wherein the electrical current limit controller controls electrical current which flows through the electric heating wire heater, so that the electrical current is less than or equal to the electrical current limit value corrected by the correction unit.

According to one or more embodiments of the image forming apparatus, the controller further includes a PWM controller to configure duty, a fourth memory to beforehand store correspondence relationship between duty and duty limit value, and a duty limit controller to control the switching element at a duty which is less than or equal to the duty limit value configured, based on the duty configured by the PWM controller and the correspondence relationship stored in the fourth memory.

According to one or more embodiments of the image forming apparatus, the duty limit controller selectively executes control at a duty which is more than or equal to a prescribed value or control at zero duty, when the duty configured by the PWM controller is less than or equal to the prescribed value.

According to one or more embodiments of the image forming apparatus, the measuring unit measures the electrical current value which flows through at least one of the electric heating wire heater, the switching element, the input alternating electrical current, and the electrical current rectified by the rectification circuit.

According to one or more embodiments of the image forming apparatus, the controller changes the electrical current limit value at timing when the input alternating current electrical voltage is close to 0V.

### BRIEF DESCRIPTION OF THE DRAWINGS

FIG. 1 shows a cross section of a structure of an image forming apparatus, according to the first embodiment of this invention.

FIG. 2 shows a control circuit for halogen heater HT in fixing device 30, according to the first embodiment of this invention.

FIG. 3 shows a table indicating the relationship between duty and the electrical current limit value, according to the first embodiment of this invention.

FIG. 4 shows a graph schematically indicating alteration from moment to moment of each of the temperature of fixing roller 31, the duty which is configured by PWM controller 5, and the electrical current which flows through halogen heater HT, according to the first embodiment of this invention.

FIG. 5 shows a flowchart of behavior of the image forming apparatus as for the configuration of the electrical current limit value, according to the first modification of the first embodiment of this invention.

FIG. 6 shows a flowchart of behavior of the image forming apparatus as for the update of an electrical current limit value, according to the second modification of the first embodiment of this invention.

FIG. 7 shows a control circuit for halogen heater HT in fixing device 30, according to the second embodiment of this invention.

FIG. 8 shows a table indicating relationship between the behavior mode of the image forming apparatus and the electrical current limit value, according to the second embodiment of this invention.

FIG. 9 shows a control circuit for halogen heater HT in fixing device 30, according to the third embodiment of this invention.

FIG. 10 shows a table indicating relationship between the temperature of fixing device 30 and the electrical current limit value, according to the third embodiment of this invention.

FIG. 11 shows a control circuit for halogen heater HT in fixing device 30, according to the fourth embodiment of this invention.

FIG. 12 shows a table indicating the relationship between electrical voltage of input alternating electrical current and the correction coefficient, according to the fourth embodiment of this invention.

FIG. 13 shows a control circuit for halogen heater HT in fixing device 30, according to the fifth embodiment of this invention.

FIG. 14 shows a table indicating the relationship between duty and the duty limit value, according to the fifth embodiment of this invention.

FIG. 15 shows a graph schematically indicating alteration from moment to moment of each of the duty configured by PWM controller 5 and the duty of PWM control signal SN6 output from duty limit controller 10, according to the fifth embodiment of this invention.

### DESCRIPTION OF EMBODIMENTS

In the following embodiments, an MFP as an image forming apparatus will be explained. An image forming apparatus may be a facsimile device, a copying machine, a printer, or the like.

### The First Embodiment

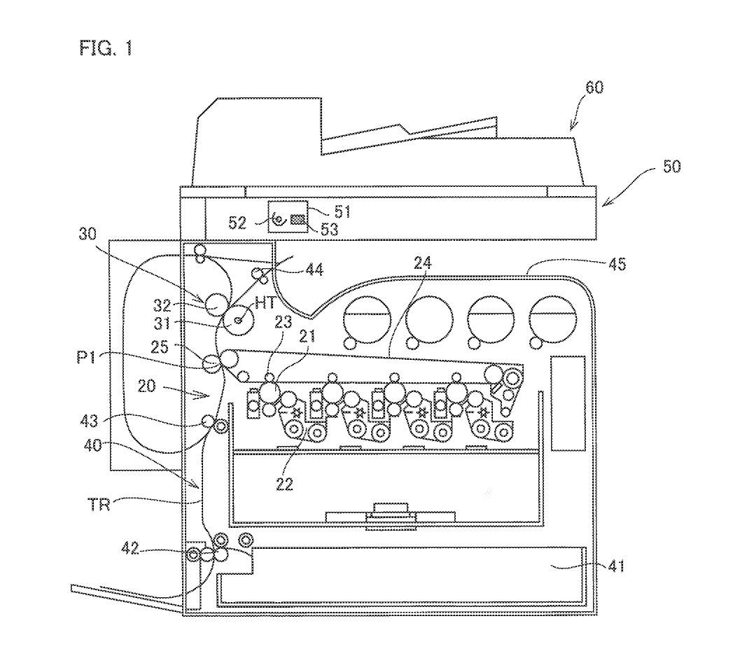

FIG. 1 shows a cross section of a structure of an image forming apparatus, according to the first embodiment of this invention.

Referring to FIG. 1, an image forming apparatus according to the embodiment includes toner image forming unit 20, fixing device 30 (an example of a fixing unit), sheet conveying unit 40, scanner 50, and ADF (Auto Document Feeder) 60.

Toner image forming unit 20 synthesizes a four-color image by so-called a tandem system, and transfers the toner image onto a sheet. Toner image forming unit 20 includes photo conductors 21, developing devices 22, primary transfer rollers 23, intermediate transfer belt 24, secondary transfer roller 25, and so on. Photo conductors 21, developing devices 22, and primary transfer rollers 23 are provided for colors of C (cyan), M (magenta), Y (yellow) and K (black). Developing devices 22 form toner images on photo conductors 21. Primary transfer rollers 23 transfer toner images from photo conductors 21 to intermediate transfer belt 24 (the primary transfer). Secondary transfer roller 25 transfers the toner image from intermediate transfer belt 24 to a sheet, at image forming location P1 (the secondary transfer).

Fixing device 30 melts toner being adhered to the sheet to fix the toner onto the sheet, so that the image is formed on the sheet. Fixing device 30 includes fixing roller 31 and pressure roller 32. Halogen heater HT (an example of an electric heating wire heater) is provided in the inner part of fixing roller 31, wherein the halogen heater HT is a heat source for fixing device 30.

Sheet conveying unit 40 includes paper feeding cartridge 41, separation unit 42, a pair of conveying rollers 43, a pair of discharge rollers 44, copy receiving tray 45, and so on. Paper feeding cartridge 41 stores sheets onto which images are to be formed. Paper feeding cartridge 41 may include a plurality of paper feeding cartridges. Separation unit 42 separates a sheet from a plurality of sheets stored in paper feeding cartridge 41, and feeds the paper sheet to conveying path TR. The pair of conveying rollers 43 conveys the sheet along with conveying path TR. The pair of discharge rollers 44 discharges the sheet on which an image was formed onto copy receiving tray 45.

Scanner 50 is placed between ADF 60 and copy receiving tray 45. Scanner 50 includes IR (Infrared) module 51 and so on. IR module 51 includes lamp 52 to irradiate a document with light, and image sensor 53 which receives reflected light from the document. IR module 51 reads a document image, to acquire the image data.

ADF 60 is provided at an upper part of the image forming apparatus. ADF 60 conveys a document on which the image is to be read by scanner 50, to the image reading location of scanner 50.

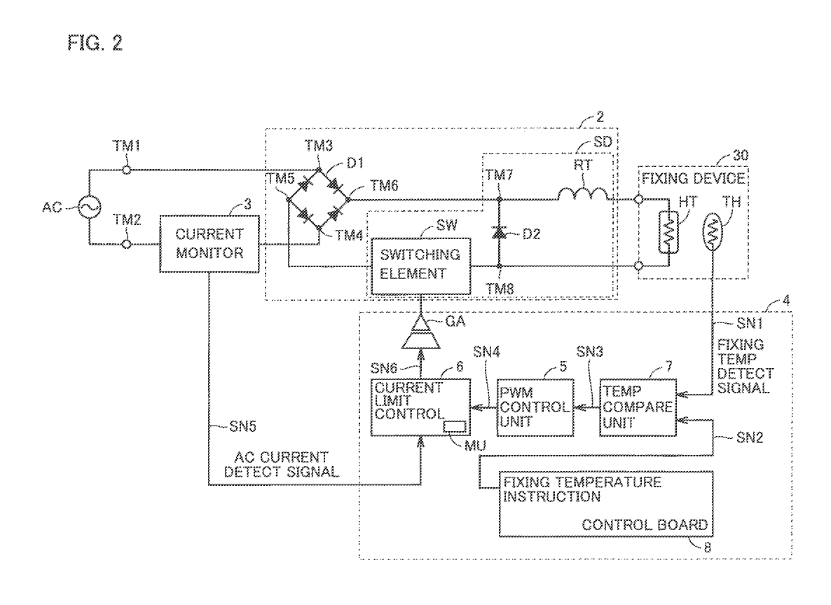

FIG. 2 shows a control circuit for halogen heater HT in fixing device 30, according to the first embodiment of this invention.

Referring to FIG. 2, fixing device 30 further includes thermistor TH which detects the temperature of fixing roller 31. The image forming apparatus detects the temperature of fixing roller 31 (the temperature of fixing device 30) by thermistor TH. The image forming apparatus performs PWM (pulse width modulation) control on halogen heater HT, so that the temperature of fixing roller 31 is adjusted to the temperature specified by fixing temperature instruction SN2.

The image forming apparatus is further equipped with current applying circuit 2 (an example of a current applying means), electrical current monitor 3 (an example of a measuring unit), and controller 4 (an example of a control means).

Current applying circuit 2 applies electrical current to halogen heater HT. Current applying circuit 2 includes rectification diodes D1 (an example of a rectification circuit), and step down chopper circuit SD. Step down chopper circuit SD is configured with switching element SW, freewheeling diode D2 (an example of a back-flow element), and choke coil RT (an example of a reactor). Terminal TM1 which is an L line of alternating current electric power supply AC is connected with terminal TM3 of rectification diodes D1. Terminal TM2 which is an N line of alternating current electric power supply AC is connected with terminal TM4 of rectification diodes D1 via electrical current monitor 3. Choke coil RT is connected between terminal TM6 of rectification diodes D1 and the one end of halogen heater HT. Switching element SW is connected between terminal TM5 of rectification diodes D1 and the other end of halogen heater HT. The cathode of freewheeling diode D2 is connected with terminal TM7 which is located between terminal TM6 and the one end of halogen heater HT. The anode of freewheeling diode D2 is connected with terminal TM8 which is located between the other end of halogen heater HT and switching element SW. Rectification diodes D1 are a diode bridge, for example. Rectification diodes D1 perform full wave rectification on input alternating electrical current which is output from alternating current electric power supply AC. Step down chopper circuit SD performs switching on electrical current rectified by rectification diodes D1, by using switching element SW, and leads the electrical current to halogen heater HT.

Electrical current monitor 3 measures the electrical current value which flows through halogen heater HT. According to the embodiment, the electrical current which flows through halogen heater HT, the electrical current which flows through switching element SW, and the input alternating electrical current (the electrical current which flows through terminal TM1 or TM2) are equal. Therefore, electrical current monitor 3 should measure the electrical current which flows through at least one of halogen heater HT, switching element SW, and the input alternating electrical current. Electrical current monitor 3 outputs AC electrical current detecting signal SN5 to electrical current limit controller 6, wherein the AC electrical current detecting signal SN5 is to indicate the measured electrical current value.

Controller 4 controls electrical current which flows through halogen heater HT, by controlling current applying circuit 2 based on the electrical current value measured by electrical current monitor 3. Controller 4 controls switching element SW by using PWM. Controller 4 includes PWM controller 5 (an example of a PWM controller), electrical current limit controller 6 (an example of an electrical current limit controller), temperature comparing unit 7, control circuit board 8, and gate amplifier GA. Each of PWM controller 5, electrical current limit controller 6, and control circuit board 8 includes a CPU (Central Processing Unit), a ROM (Read Only Memory) to store control programs executed by the CPU, a RAM (Random Access Memory) which is a work area for the CPU, and so on. Electrical current limit controller 6 includes storage MU to store various tables.

Control circuit board 8 controls the entire of the image forming apparatus.

Temperature comparing unit 7 receives fixing temperature detecting signal SN1 and fixing temperature instruction SN2. Fixing temperature detecting signal SN1 is for indicating the temperature of fixing roller 31 detected by thermistor TH. Fixing temperature instruction SN2 is for indicating fixing temperature configured by control circuit board 8. Temperature comparing unit 7 outputs comparing signal SN3 to PWM controller 5, wherein the comparing signal SN3 shows the comparison result between the temperature of fixing roller 31 and the configured fixing temperature. More specifically, when the temperature of fixing roller 31 is lower than the configured fixing temperature, temperature comparing unit 7 issues an instruction to increase the PWM duty. When the temperature of fixing roller 31 is higher than the configured fixing temperature, temperature comparing unit 7 issues an instruction to decrease the PWM duty.

PWM controller 5 configures the PWM duty in response to comparing signal SN3, and outputs PWM signal SN4 which shows the configured duty, to electrical current limit controller 6.

Electrical current limit controller 6 receives PWM signal SN4 and AC electrical current detecting signal SN5. Electrical current limit controller 6 performs PWM control on switching element SW, based on electrical current value measured by electrical current monitor 3 and the duty configured by PWM controller 5, to control electrical current which flows through halogen heater HT.

Gate amplifier GA is for driving switching element SW. Electrical current limit controller 6 outputs PWM control signal SN6 to gate amplifier GA. PWM control signal SN6 is amplified by gate amplifier GA, and is output to switching element SW.

Controller 4 sets the electrical current limit value to a value linked to a magnitude of the stable state electrical current. Hence, controller 4 controls the electrical current which flows through halogen heater HT, so that the electrical current is less than or equal to the electrical current limit value which was set. The magnitude of the stable state electrical current is normally linked to the magnitude of the PWM duty which controls switching element SW. More specifically, when the electrical current which flows through halogen heater HT exceeded the electrical current limit value which was configured, electrical current limit controller 6 turns switching element SW off, to turn the electrical power supply to halogen heater HT off. When the electrical current which flows through halogen heater HT fell below the electrical current limit value which was configured, electrical current limit controller 6 restarts PWM control.

The stable state electrical current is an electrical current value when the electrical current which flows through halogen heater HT is stable. For example, the average value of the electrical current which flows through halogen heater HT, when a state in which the electrical current which flows through halogen heater HT is lower than a prescribed value continues for a certain period of time, may be determined as stable state electrical current. Or, the average value of the electrical current which flows through halogen heater HT, when the period of a predetermined time has elapsed after control of the switching element under a constant duty was started, may be determined as stable state electrical current.

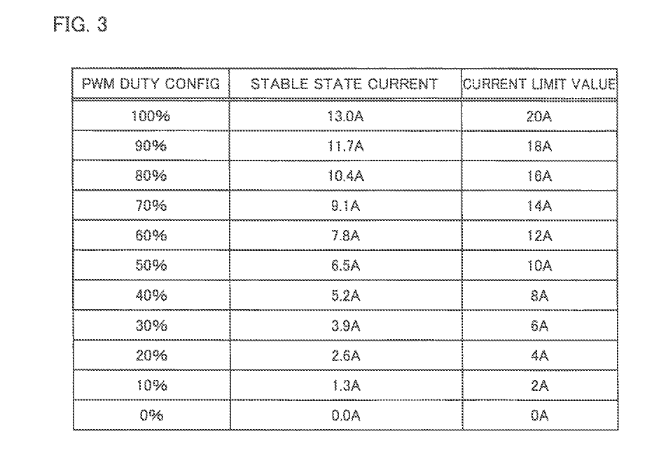

Electrical current limit controller 6 according to the embodiment configures an electrical current limit value, based on the duty configured by PWM controller 5 and correspondence relationship described in the table of FIG. 3. Electrical current limit controller 6 controls the electrical current which flows through halogen heater HT, so that the electrical current is less than or equal to the electrical current limit value which was set.

FIG. 3 shows a table indicating the correspondence relationship between duty and the electrical current limit value, according to the first embodiment of this invention.

Referring to FIG. 3, this table is stored in the storage MU (an example of the first memory means) in electrical current limit controller 6. This table includes the item of the duty configured by PWM controller 5, the item of the stable state electrical current, and the item of the electrical current limit value. As the duty configured by PWM controller 5 lowers, the stable state electrical current becomes smaller, and the electrical current limit value configured becomes smaller.

For example, when the duty configured by PWM controller 5 is 100%, electrical current limit controller 6 controls the electrical current which flows through halogen heater HT so that the electrical current is less than or equal to 20 A (ampere). When the duty configured by PWM controller 5 is 40%, electrical current limit controller 6 controls the electrical current which flows through halogen heater HT so that the electrical current is less than or equal to 8 A.

In terms of breakage prevention of switching element SW, the electrical current limit value should be configured to a value being less than or equal to the upper limit of the allowable range of electrical current which can flow through switching element SW.

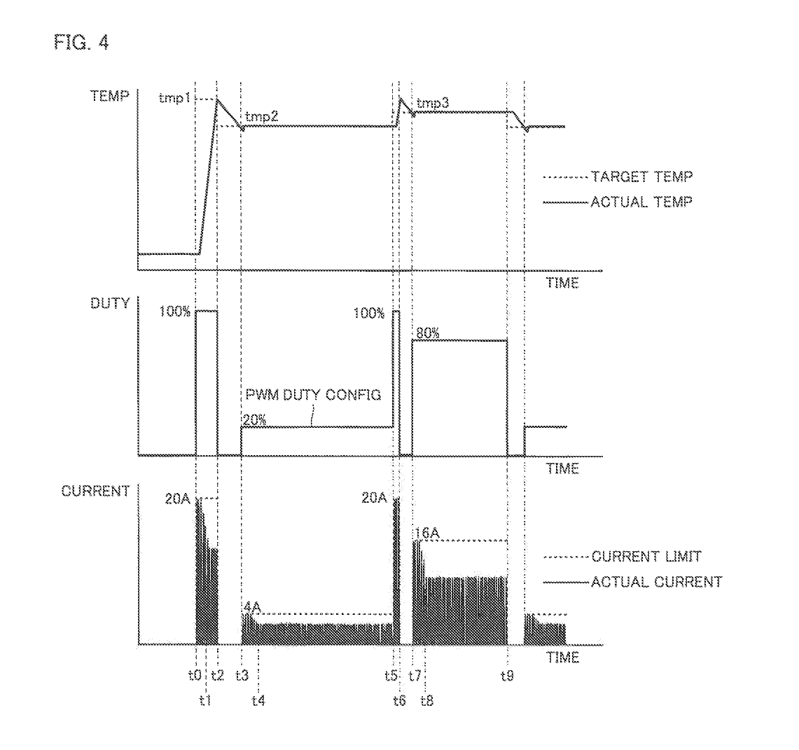

FIG. 4 shows a graph schematically indicating alteration from moment to moment of each of the temperature of fixing roller 31, the duty which is configured by PWM controller 5, and the electrical current which flows through halogen heater HT, according to the first embodiment of this invention.

Referring to FIG. 4, at clock time t0, when the electric power supply of the image forming apparatus is turned on, the image forming apparatus enters the warm-up behavior mode. PWM controller 5 sets the duty to a high value (100% in this embodiment), to heat fixing roller 31 to the target temperature tmp1. Electrical current limit controller 6 sets the electrical current limit value to 20 A, based on the table shown by FIG. 3, to control the electrical current which flows through halogen heater HT so that the electrical current is less than or equal to 20 A. Halogen heater HT is firstly in an unstable state in which inrush electrical current flows, due to rapid duty change. However, according to the electrical current limit value, the inrush electrical current is suppressed.

At clock time t1, the electrical current which flows through halogen heater HT is in a stable condition. The electrical current is 13 A which is stable state electrical current when the duty is 100%.

At clock time t2, when the temperature of fixing roller 31 reaches the target temperature tmp1, the image forming apparatus enters the stand-by behavior mode. PWM controller 5 once sets the duty to zero, to stop heating fixing roller 31.

At clock time t3, when the temperature of fixing roller 31 falls below the target temperature tmp2 (<tmp1), PWM controller 5 sets the duty to a low value (20% in this embodiment), to maintain the temperature of fixing roller 31 at the target temperature tmp2. Electrical current limit controller 6 sets the electrical current limit value to 4 A based on the table shown by FIG. 3, to control the electrical current which flows through halogen heater HT so that the electrical current is less than or equal to 4 A. Halogen heater HT is firstly in an unstable state in which inrush electrical current flows, due to rapid duty change. However, the inrush electrical current is suppressed so that the inrush electrical current is less than or equal to the electrical current limit value.

At clock time t4, the electrical current which flows through halogen heater HT is in a stable condition. The electrical current is 2.6 A, which is stable state electrical current when the duty is 20%.

At clock time t5, when the image forming apparatus receives an instruction of performing a printing job, the image forming apparatus enters the warm-up behavior mode. PWM controller 5 sets the duty to a high value (100% in this embodiment), and heats fixing roller 31 to a temperature which is higher than the target temperature tmp3 (>tmp2). Electrical current limit controller 6 sets the electrical current limit value to 20 A based on the table shown by FIG. 3, and controls the electrical current which flows through halogen heater HT so that the electrical current is less than or equal to 20 A. Halogen heater HT is firstly in an unstable state in which inrush electrical current flows due to rapid duty change. However, the inrush electrical current is suppressed so that the inrush electrical current is less than or equal to the electrical current limit value.

At clock time t6, when the temperature of fixing device 30 reaches a temperature which is higher than the target temperature tmp3, the image forming apparatus enters the print behavior mode. PWM controller 5 once sets the duty to zero, and stops heating of fixing roller 31.

At clock time t7, when the temperature of fixing device 30 falls below the target temperature tmp3, PWM controller 5 sets the duty to a moderate value (80% in the embodiment), and keeps the temperature of fixing roller 31 at temperature tmp3. Electrical current limit controller 6 sets the electrical current limit value to 16 A based on the table shown by FIG. 3, and controls the electrical current which flows through halogen heater HT so that the electrical current is less than or equal to 16 A. Halogen heater HT is firstly in an unstable state in which inrush electrical current flows due to rapid duty change. However, the inrush electrical current is suppressed, so that the inrush electrical current is less than or equal to the electrical current limit value.

At clock time t8, the electrical current which flows through halogen heater HT is in a stable condition, and is 10.4 A which is stable state electrical current when the duty is 80%. After that, at clock time t9 after completion of the printing job, PWM controller 5 sets the duty to zero, and stops heating of fixing roller 31.

The timing when the electrical current limit value is changed is a timing when the input alternating current electrical voltage is close to 0V.

According to this embodiment, the electrical current limit value when the heater is turned on (when electrical current begins to flow through halogen heater HT) is set in conjunction with the magnitude of the stable state electrical current. Hence, the difference between electrical current when the heater is turned on and the stable state electrical current is small. Herewith, for example, when the average value of the electrical current which flows through halogen heater HT is small, such as when the image forming apparatus is in the stand-by behavior mode, the fluctuation of input electrical voltage of alternating current electric power supply AC can be suppressed. Therefore, a flicker can be remedied. Further, inrush electrical current when the heater is turned on is suppressed, so that terminal noise can be reduced.

[The First Modification of the First Embodiment]

Referring to FIGS. 2 to 4, according to this modification, electrical current limit controller 6 calculates the electrical current limit value by using electrical current value measured by electrical current monitor 3. When the electrical current which flows through halogen heater HT is stable (clock time from t1 to t2, clock time from t4 to t5, and clock time from t8 to t9 in FIG. 4), electrical current limit controller 6 controls the electrical current which flows through halogen heater HT so that the electrical current is less than or equal to the calculated electrical current limit value. Electrical current limit controller 6 may set the electrical current limit value to the product of the electrical current value measured by electrical current monitor 3 multiplied by a predetermined constant value (for example, 1.5).

On the other hand, when the electrical current which flows through halogen heater HT is unstable (clock time from t0 to t1, clock time from t3 to t4, clock time from t5 to t6, and clock time from t7 to t8 in FIG. 4), electrical current limit controller 6 controls the electrical current which flows through halogen heater HT, so that the electrical current is less than or equal to the electrical current limit value which was configured based on the correspondence relationship of the table of FIG. 3, according to a control method similar to the first embodiment.

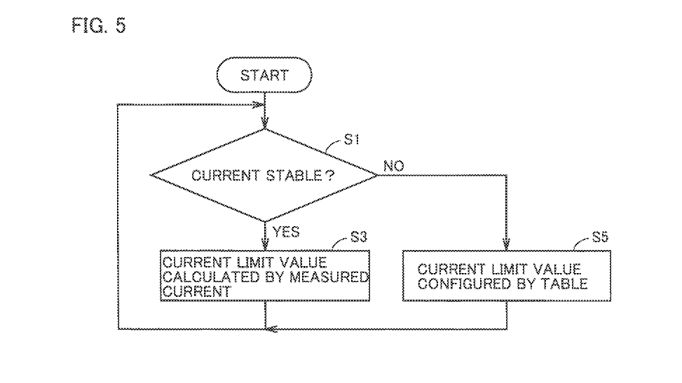

FIG. 5 shows a flowchart of behavior of the image forming apparatus as for the configuration of the electrical current limit value, according to the first modification of the first embodiment of this invention.

Referring to FIG. 5, the CPU in electrical current limit controller 6 refers to the electrical current value measured by electrical current monitor 3, and determines whether the electrical current which flows through halogen heater HT is stable or not (S1).

At step S1, when the electrical current which flows through halogen heater HT is stable (YES at S1), the CPU in electrical current limit controller 6 uses the electrical current limit value calculated by using the measured electrical current value (S3), and steps in the process of step S1.

At step S1, when the electrical current which flows through halogen heater HT is unstable (NO at S1), the CPU in electrical current limit controller 6 uses the electrical current limit value which was configured by using the table (S5), and steps in the process of step S1.

According to this modification, when the electrical current which flows through halogen heater HT is stable, there is no necessity to configure the electrical current limit value by referring to the table. Hence, simplification of the control can be achieved.

[The Second Modification of the First Embodiment]

Referring to FIGS. 2 to 4, according to this modification, after the electrical current which flows through halogen heater HT becomes stable, electrical current limit controller 6 calculates new electrical current limit value by using the electrical current value measured by electrical current monitor 3. Electrical current limit controller 6 updates the electrical current limit value described in the table of FIG. 3, to the newly calculated electrical current limit value. Electrical current limit controller 6 may set the new electrical current limit value to the product of the electrical current value measured by electrical current monitor 3 multiplied by a predetermined constant value (for example, 1.5).

For example, it is assumed that the electrical current value measured by electrical current monitor 3 (namely, the actual stable state electrical current) is 12.0 A, after the electrical current which flows through halogen heater HT became stable, when the duty configured by PWM controller 5 is 100%. At this time, electrical current limit controller 6 calculates 18.0 A which is the new electrical current limit value by multiplying 12.0 A by 1.5, and updates 20 A which is the electrical current limit value in the table of FIG. 3 to 18.0 A. The new electrical current limit value is used as the electrical current limit value after that.

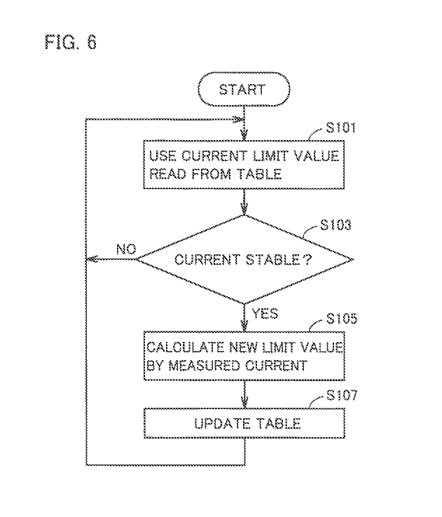

FIG. 6 shows a flowchart of behavior of the image forming apparatus as for the update of the electrical current limit value, according to the second modification of the first embodiment of this invention.

Referring to FIG. 6, the CPU in electrical current limit controller 6 controls the electrical current which flows through halogen heater HT by using the electrical current limit value read from the table (S101). Next, the CPU in electrical current limit controller 6 refers to electrical current value measured by electrical current monitor 3, and determines whether the electrical current which flows through halogen heater HT is stable or not (S103).

At step S103, when the electrical current which flows through halogen heater HT is unstable (NO at S103), the CPU in electrical current limit controller 6 steps in the process of step S101.

At step S103, when the electrical current which flows through halogen heater HT is stable (YES at S103), the CPU in electrical current limit controller 6 calculates the new electrical current limit value by using the measured electrical current value (S105). Next, the CPU in electrical current limit controller 6 updates the relevant electrical current limit value in the table (S107), and steps in the process of step S101.

This modification can be combined with the first embodiment, or the first modification of the first embodiment.

According to this embodiment, the electrical current limit value is configured, based on the actual stable state electrical current. Hence, the electrical current which flows through halogen heater HT can be controlled by using more proper electrical current limit value.

### The Second Embodiment

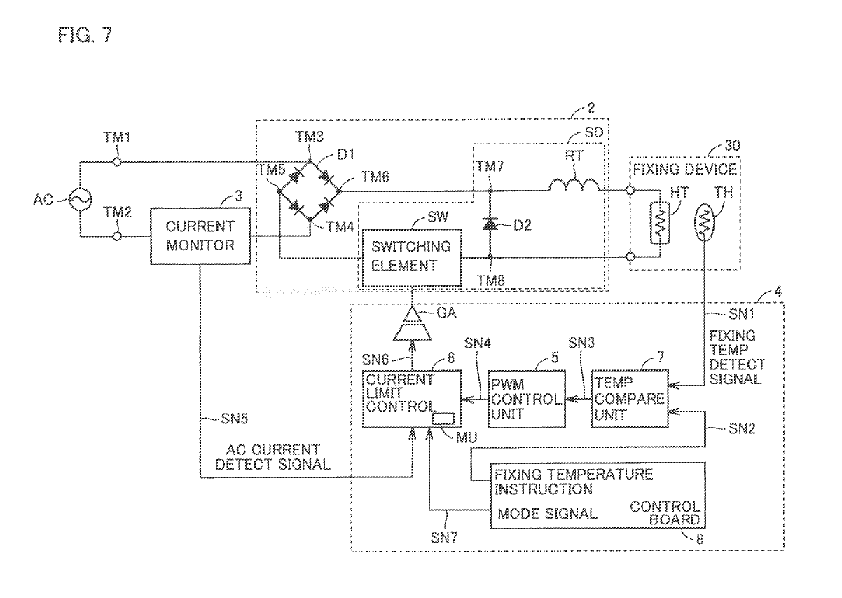

FIG. 7 shows a control circuit for halogen heater HT in fixing device 30, according to the second embodiment of this invention.

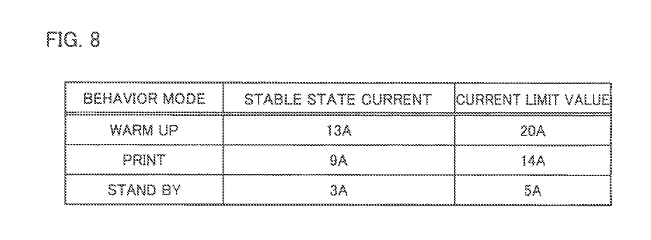

Referring to FIG. 7, control circuit board 8 outputs fixing temperature instruction SN2 to temperature comparing unit 7, and outputs behavior mode signal SN7 to electrical current limit controller 6. Behavior mode signal SN7 is to indicate the actual behavior mode of the image forming apparatus. Electrical current limit controller 6 configures the electrical current limit value, based on the actual behavior mode of the image forming apparatus and correspondence relationship indicated by the table of FIG. 8. Electrical current limit controller 6 controls the electrical current which flows through halogen heater HT, so that the electrical current is less than or equal to the electrical current limit value which was set.

FIG. 8 shows a table indicating relationship between the behavior mode of the image forming apparatus and the electrical current limit value, according to the second embodiment of this invention.

Referring to FIG. 8, this table is stored in storage MU (an example of a second memory means) of electrical current limit controller 6. The table includes the item of the behavior mode, the item of the stable state electrical current, the item of the electrical current limit value. The behavior modes include warm-up, print, and stand-by. The magnitude of the stable state electrical current and the electrical current limit value are reduced in the order of warm-up, print, and stand-by.

More specifically, when the actual behavior mode of the image forming apparatus is warm-up, electrical current limit controller 6 sets the electrical current limit value to 20 A, and controls the electrical current which flows through halogen heater HT so that the electrical current is less than or equal to 20 A. When the actual behavior mode of the image forming apparatus is print, electrical current limit controller 6 sets the electrical current limit value to 14 A, and controls the electrical current which flows through halogen heater HT so that the electrical current is less than or equal to 14 A. When the actual behavior mode of the image forming apparatus is stand-by, electrical current limit controller 6 sets the electrical current limit value to 5 A, and controls the electrical current which flows through halogen heater HT so that the electrical current is less than or equal to 5 A.

The structures and behavior of the image forming apparatus according to the embodiment other than the above-mentioned are similar to the structures and behavior of the image forming apparatus according to the first embodiment. The same numerals are provided for same components. The explanation is not repeated.

According to this embodiment, the effect similar to the first embodiment can be obtained. In addition, the proper electrical current limit value can be set, in response to the actual behavior mode of the image forming apparatus. The proper electric power can be supplied to halogen heater HT.

### The Third Embodiment

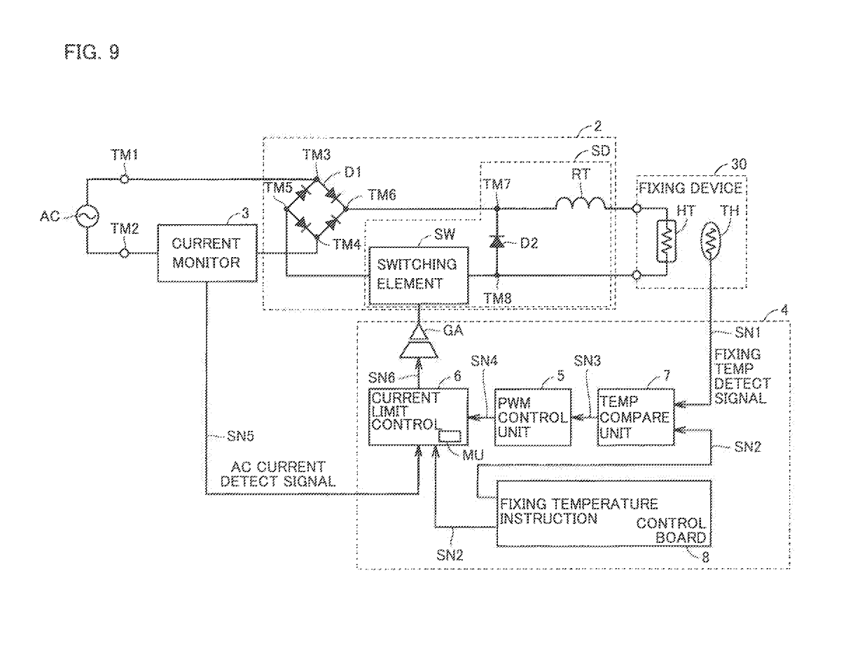

FIG. 9 shows a control circuit for halogen heater HT in fixing device 30, according to the third embodiment of this invention.

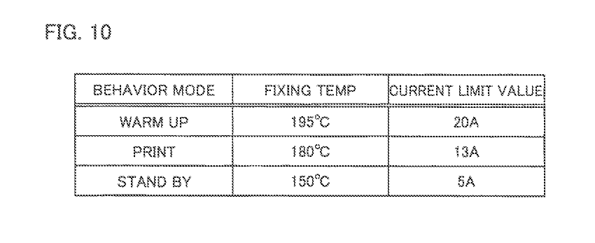

Referring to FIG. 9, control circuit board 8 transmits fixing temperature instruction SN2 to temperature comparing unit 7 and to electrical current limit controller 6. Electrical current limit controller 6 sets the electrical current limit value, based on the temperature of fixing device 30 in the received fixing temperature instruction SN2 and correspondence relationship of the table shown in FIG. 10, and controls the electrical current which flows through halogen heater HT, so that the electrical current is less than or equal to the electrical current limit value which was set.

FIG. 10 shows a table indicating relationship between the temperature of fixing device 30 and the electrical current limit value, according to the third embodiment of this invention.

Referring to FIG. 10, this table is stored in storage MU (an example of a third memory means) of electrical current limit controller 6. This table includes the item of behavior mode, the item of the temperature of fixing device 30 (fixing temperature), and the item of the electrical current limit value. The electrical current limit value decreases with decreasing the fixing temperature.

More specifically, when the configured fixing temperature is 195 degrees Celsius (which corresponds to the case in which the behavior mode of the image forming apparatus is warm-up), electrical current limit controller 6 sets the electrical current limit value to 20 A. When the configured fixing temperature is 180 degrees Celsius (which corresponds to the case in which the behavior mode of the image forming apparatus is print), electrical current limit controller 6 sets the electrical current limit value to 13 A. When the configured fixing temperature is 150 degrees Celsius (which corresponds to the case in which the behavior mode of the image forming apparatus is stand-by), electrical current limit controller 6 sets the electrical current limit value to 5 A.

Normally, when the behavior mode of the image forming apparatus is stand-by, the fixing temperature which is lower than other behavior modes is set. During the stand-by state, sheets do not pass through fixing device 30, and do not draw heat from fixing device 30, so that the electrical current which flows through halogen heater HT can be lowered and the electrical current limit value can be lowered.

The structures and behavior of the image forming apparatus according to the embodiment other than the above-mentioned are similar to the structures and behavior of the image forming apparatus according to the first embodiment. The same numerals are provided for same components. The explanation is not repeated.

According to this embodiment, the effect similar to the first embodiment can be obtained. In addition, a flicker can be remedied even though the configured fixing temperature is low and average electrical current which flows through halogen heater HT is small.

### The Fourth Embodiment

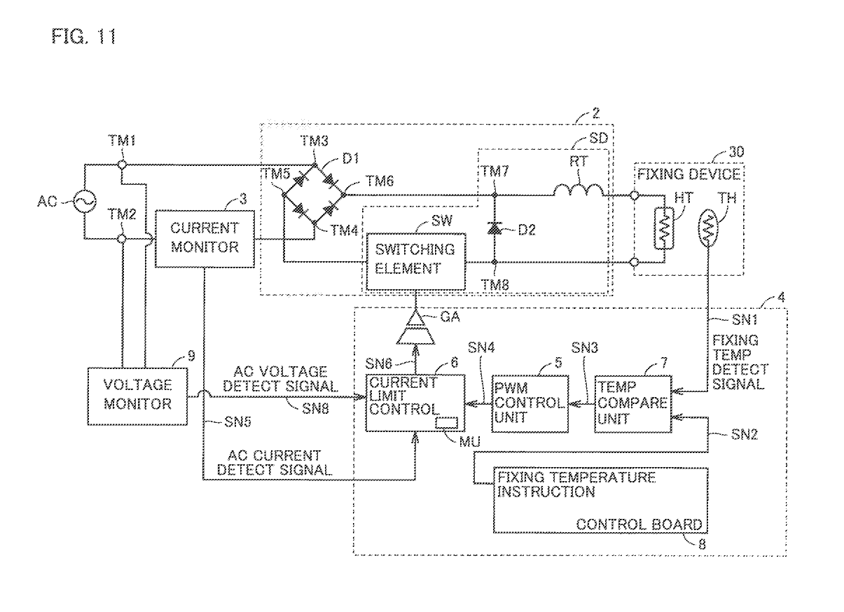

FIG. 11 shows a control circuit for halogen heater HT in fixing device 30, according to the fourth embodiment of this invention.

Referring to FIG. 11, the image forming apparatus is further equipped with electrical voltage monitor 9. Electrical voltage monitor 9 is connected between terminal TM1 and terminal TM2, to measure electrical voltage of input alternating electrical current. Electrical voltage monitor 9 outputs AC electrical voltage detecting signal SN8 to electrical current limit controller 6. AC electrical voltage detecting signal SN8 indicates the measured electrical voltage.

Electrical current limit controller 6 sets a temporary electrical current limit value, by the method of one of the first to the third embodiments. After that, electrical current limit controller 6 sets the electrical current limit value, by correcting the temporary electrical current limit value in response to electrical voltage measured by electrical voltage monitor 9. More specifically, when the electrical voltage measured by electrical voltage monitor 9 is higher than a predetermined electrical voltage value (230V in this embodiment), electrical current limit controller 6 corrects the temporary electrical current limit value so that the electrical current limit value lowers. When the electrical voltage measured by electrical voltage monitor 9 is lower than the predetermined electrical voltage value, electrical current limit controller 6 corrects the temporary electrical current limit value, so that the electrical current limit value gets higher. Then, electrical current limit controller 6 controls the electrical current which flows through halogen heater HT, so that the electrical current is less than or equal to the corrected electrical current limit value.

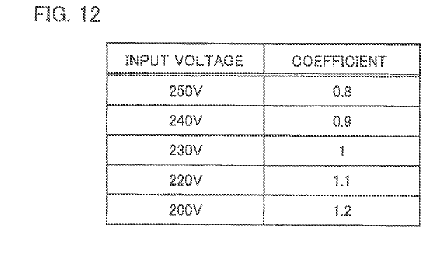

Electrical current limit controller 6 determines a correction coefficient based on the electrical voltage measured by electrical voltage monitor 9 and correspondence relationship of the table shown in FIG. 12. Electrical current limit controller 6 calculates the product of the temporary electrical current limit value multiplied by the correction coefficient, to correct the electrical current limit value.

FIG. 12 shows a table indicating the relationship between electrical voltage of input alternating electrical current and the correction coefficient, according to the fourth embodiment of this invention.

Referring to FIG. 12, this table is stored in storage MU in electrical current limit controller 6. The table includes the item of electrical voltage of the input alternating electrical current, and the item of the correction coefficient. The correction coefficient increases with lowering the electrical voltage of the input alternating current electrical voltage which was measured by electrical voltage monitor 9.

For example, when the electrical voltage of the input alternating electrical current is 250V, electrical current limit controller 6 sets the correction coefficient to 0.8. When the electrical voltage of the input alternating electrical current is 230V, electrical current limit controller 6 sets the correction coefficient to 1. When the electrical voltage of the input alternating electrical current is 200V, electrical current limit controller 6 sets the correction coefficient to 1.2.

The structures and behavior of the image forming apparatus according to the embodiment other than the above-mentioned are similar to the structures and behavior of the image forming apparatus according to the first embodiment. The same numerals are provided for same components. The explanation is not repeated.

According to this embodiment, the effect similar to the first embodiment can be obtained. In addition, when the environment of alternating current electric power supply AC which provides electric power to the image forming apparatus is poor, and fluctuation of the electrical voltage of the input alternating electrical current of the alternating current electric power supply AC is large, the electrical current which flows through halogen heater HT can be suitably controlled, so that a flicker can be remedied. More specifically, when the electrical voltage of the input alternating electrical current is low, the electrical current which flows through halogen heater HT is increased, to suppress the unnecessary delay of temperature rising of fixing roller 31. When the electrical voltage of the input alternating electrical current is high, the electrical current which flows through halogen heater HT is suppressed, so that unnecessary acceleration of temperature rising of fixing roller 31 is suppressed.

### The Fifth Embodiment

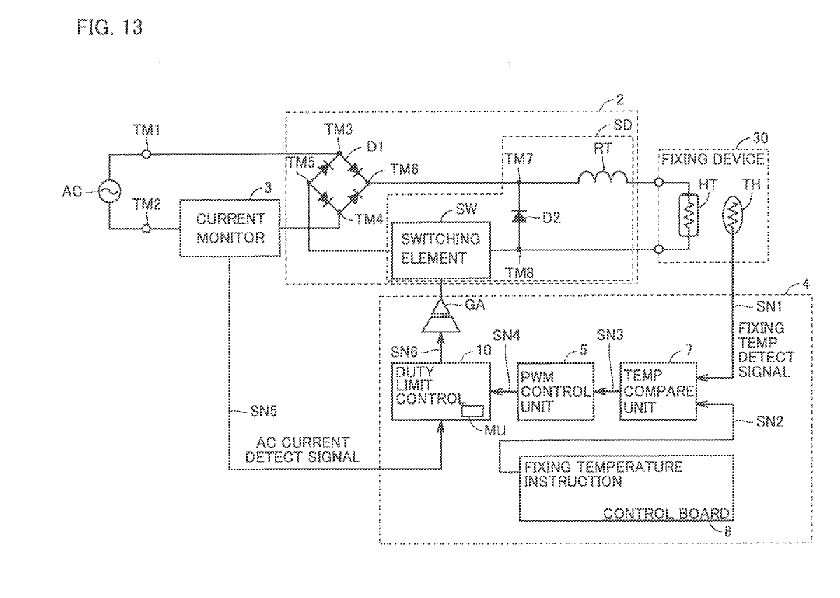

FIG. 13 shows a control circuit for halogen heater HT in fixing device 30, according to the fifth embodiment of this invention.

Referring to FIG. 13, controller 4 includes duty limit controller 10 as substitute for the electrical current limit controller. Duty limit controller 10 configures the duty, and outputs PWM control signal SN6 of the configured duty to gate amplifier GA.

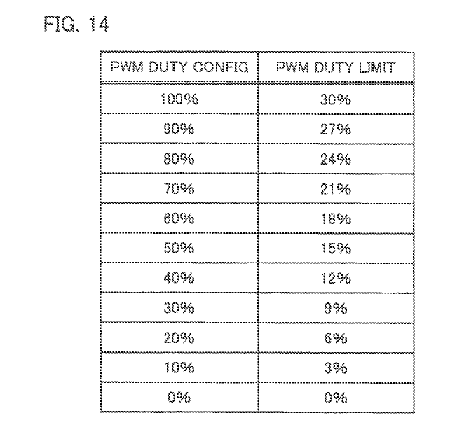

Duty limit controller 10 controls switching element SW by the configured duty from start of the PWM control to when the electrical current which flows through halogen heater HT becomes stable, wherein the duty is less than or equal to the duty limit value which is set based on the duty configured by PWM controller 5 and correspondence relationship of the table shown in FIG. 14.

FIG. 14 shows a table indicating the relationship between duty and the duty limit value, according to the fifth embodiment of this invention.

Referring to FIG. 14, this table is stored in storage MU (an example of a fourth memory means) of duty limit controller 10. This table includes the item of duty, and the item of the duty limit value. The duty limit value decreases with decreasing the duty.

For example, when the duty configured by PWM controller 5 is 100%, duty limit controller 10 sets the duty limit value to 30%. When the duty configured by PWM controller 5 is 20%, duty limit controller 10 sets the duty limit value to 6%.

When the duty configured by PWM controller 5 is less than or equal to a prescribed value, duty limit controller 10 executes control at the duty being more than or equal to the prescribed value or control at the duty of zero, selectively.

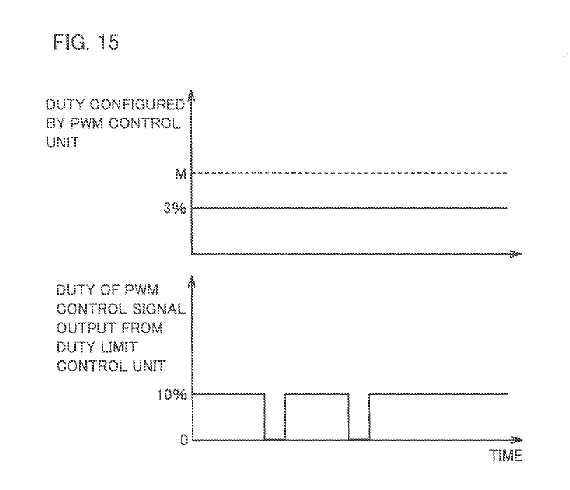

FIG. 15 shows a graph schematically indicating alteration from moment to moment of each of the duty configured by PWM controller 5 and the duty of PWM control signal SN6 output from duty limit controller 10, according to the fifth embodiment of this invention.

Referring to FIG. 15, the duty configured by PWM controller 5 is 3% which is less than or equal to prescribed value M (for example, 8%). In this instance, the duty of PWM control signal SN6 output from duty limit controller 10 is selectively switched between 10% which is more than or equal to prescribed value M and zero.

The structures and behavior of the image forming apparatus according to the embodiment other than the above-mentioned are similar to the structures and behavior of the image forming apparatus according to the first embodiment. The same numerals are provided for same components. The explanation is not repeated.

According to this embodiment, the effect similar to the first embodiment can be obtained. In addition, since inrush electrical current at the start of PWM control can be suppressed, a flicker is remedied. Further, since the halogen cycle of halogen heater HT works in a normal way, deterioration in a lifetime can be suppressed.

[Others]

The structure of the rectification circuit is arbitrary. The rectification circuit can be a full wave rectification circuit as mentioned is the above embodiments. The rectification circuit may be a half-wave rectification circuit or the like.

Although the disclosure has been described with respect to only a limited number of embodiments, those skilled in the art, having benefit of this disclosure, will appreciated that various other embodiments may be devised without departing from the scope of the present invention. Accordingly, the scope of the invention should be limited only by the attached claims.

What is claimed is:

1. An image forming apparatus comprising:
a fixing unit comprising a roller and an electric heating wire heater,
a current applying circuit that applies electrical current to the electric heating wire heater,
a measuring unit electrically connected to the current applying circuit and that measures a value of electrical current that flows through the electric heating wire heater, and
a controller that controls the electrical current that flows through the electric heating wire heater by controlling the current applying circuit based on the electrical current value measured by the measuring unit, wherein
the controller controls the electrical current to be less than or equal to an electrical current limit value, and
a magnitude of the electrical current limit value is linked to a magnitude of stable state electrical current.

2. The image forming apparatus according to claim 1, wherein
the electric heating wire heater is a halogen heater, and
the current applying circuit comprises:
a rectification circuit that rectifies an input alternating electrical current; and
a step down chopper circuit comprising a switching element, a back-flow element, and a reactor,
the step down chopper circuit switches the input alternating electrical current rectified by the rectification circuit by switching the switching element on or off, and applies the electrical current to the electric heating wire heater,
the controller controls the switching element using pulse width modulation (PWM), and
the magnitude of the stable state electrical current is linked to a magnitude of the duty of the PWM.

3. The image forming apparatus according to claim 2, wherein the controller comprises:
a PWM controller that controls the duty of the PWM, and
an electrical current limit controller that controls the electrical current by controlling the switching element based on the electrical current value measured by the measuring unit and the duty of the PWM.

4. The image forming apparatus according to claim 3, wherein
the controller further comprises a first memory that stores a correspondence relationship between the duty of the PWM and the electrical current limit value, and
the electrical current limit controller controls the electrical current to be less than or equal to an electrical current limit value that is based on the duty of the PWM and the correspondence relationship stored in the first memory.

5. The image forming apparatus according to claim 4, wherein
the controller calculates the electrical current limit value using the electrical current value measured by the measuring unit,
when the electrical current is unstable, the electrical current limit controller controls the electrical current to be less than or equal to the electrical current limit value that is based on the correspondence relationship stored in the first memory, and
when the electrical current is stable the electrical current limit controller controls electrical current to be less than or equal to the calculated electrical current limit value.

6. The image forming apparatus according to claim 4, wherein
the controller calculates a new electrical current limit value by using the electrical current value measured by the measuring unit, after the electrical current becomes stable, and
the controller updates the electrical current limit value stored in the first memory with the calculated new electrical current limit value.

7. The image forming apparatus according to claim 3, wherein
the controller further comprises a second memory that stores a correspondence relationship between behavior modes of the image forming apparatus and electrical current limit values,
the behavior modes include warm-up, print and stand-by, and the electrical current limit value second memory decreases in the order of an electrical current limit value of the warm-up, an electrical current limit value of the print, and an electrical current limit value of the stand-by, and
the electrical current limit controller controls the electrical current to be less than or equal to an electrical current limit value that is based on an actual behavior mode of the image forming apparatus and the correspondence relationship stored in the second memory.

8. The image forming apparatus according to claim 3, wherein
the controller further receives a temperature configuration of the fixing unit,
the controller further comprises a third memory that stores a correspondence relationship between the temperature configuration of the fixing unit and the electrical current limit value, and
the electrical current limit controller controls the electrical current to be less than or equal to an electrical current limit value that is based on the temperature configuration of the fixing unit and the correspondence relationship stored in the third memory.

9. The image forming apparatus according to claim 3, wherein
the electrical current limit controller controls the electrical current to be less than or equal to an upper limit of an allowable range of electrical current that can flow through the switching element.

10. The image forming apparatus according to claim 3, further comprising:
an electrical voltage measuring unit electrically connected to the current applying circuit and the controller, and that measures the electrical voltage of the input alternating electrical current, wherein
the controller further corrects the electrical current limit value by decreasing the electrical current limit value when the measured electrical voltage is higher than a predetermined electrical voltage value, and corrects the electrical current limit value by increasing the electrical current limit value when the measured electrical voltage is lower than a predetermined electrical voltage value, and
the electrical current limit controller controls the electrical current to be less than or equal to the electrical current limit value corrected by the controller.

11. The image forming apparatus according to claim 2, wherein
the controller further comprises:
a PWM controller to control duty of the PWM; and
a fourth memory that stores correspondence relationship between the duty of the PWM and a duty limit value,
the controller controls the switching element at a duty that is less than or equal to the duty limit value, and
the duty limit value is based on the duty of the PWM and the correspondence relationship stored in the fourth memory.

12. The image forming apparatus according to claim 11, wherein
when the duty of the PWM controller is less than or equal to a prescribed value, the controller executes control either at a duty that is greater than or equal to the prescribed value or at zero duty.

13. The image forming apparatus according to claim 2, wherein
the measuring unit measures the electrical current value which flows through at least one of the electric heating wire heater, the switching element, and the rectification circuit.

14. The image forming apparatus according to claim 1, wherein
the controller changes the electrical current limit value at timing when the electrical voltage of the input alternating current is close to 0V.

15. A non-transitory computer-readable recording medium storing a controlling program for an image forming apparatus, wherein
the image forming apparatus comprises:
a fixing unit comprising a roller and an electric heating wire heater; and
a current applying circuit to apply electrical current to the electric heating wire heater,
the controlling program causes a computer to:
measure an electrical current value which flows through the electric heating wire heater, and
control electrical current that flows through the electric heating wire heater, by controlling the current applying circuit, based on the measured electrical current value,
the controlling of the electrical current comprises controlling the electrical current so that the electrical current is less than or equal to an electrical current limit value, and
a magnitude of the electrical current limit value is linked to a magnitude of stable state electrical current.

16. The non-transitory computer-readable recording medium according to claim 15, wherein
the electric heating wire heater is a halogen heater, and
the current applying circuit comprises:
a rectification circuit that rectifies input alternating electrical current; and
a step down chopper circuit comprising a switching element, a back-flow element and a reactor,
the step down chopper circuit switches the electrical current rectified by the rectification circuit by the switching element on and off, and applies the electrical current to the electric heating wire heater,
the controlling program further causes the computer to control the switching element using PWM, and
the magnitude of the stable state electrical current is linked to a magnitude of the duty of the PWM.

17. The non-transitory computer-readable recording medium according to claim 16, wherein
the controlling program further causes the computer to:
control a duty of the PWM, and
control the electrical current by controlling the switching element based on the measured electrical current value and the duty of the PWM.

18. The non-transitory computer-readable recording medium according to claim 17, wherein
the image forming apparatus further comprises
a first memory that stores correspondence relationship between the duty of the PWM and the electrical current limit value, wherein
the controlling program further causes the computer to control the electrical current to be less than or equal to an electrical current limit value that is based on the duty of the PWM and the correspondence relationship stored in the first memory.

19. The non-transitory computer-readable recording medium according to claim 18, wherein
the controlling program further causes the computer to:
calculate the electrical current limit value using the measured electrical current value,
control the electrical current to be less than or equal to the electrical current limit value that is based on the correspondence relationship stored in the first memory when the electrical current is unstable, and
control the electrical current to be less than or equal to the electrical current limit value that was calculated by the computer when the electrical current is stable.

20. The non-transitory computer-readable recording medium according to claim 18, wherein
the controlling program further causes the computer to:
calculate a new electrical current limit value using the measured electrical current value after the electrical current becomes stable, and
update the electrical current limit value stored in the first memory with the new electrical current limit value.
